(19) United States
(12) Patent Application Publication
(10) Pub. No.: US 2025/0061014 A1
(43) Pub. Date: Feb. 20, 2025

(54) Power Supply Fault Prediction

(71) Applicant: Telefonaktiebolaget LM Ericsson ( publ), Stockholm (SE)

(72) Inventors: Lackis Eleftheriadis, Valbo (SE); Agustin Valencia, Luleå (SE); Oleg Gorbatov, Luleå (SE)

(21) Appl. No.: 18/710,965

(22) PCT Filed: Nov. 24, 2021
(86) PCT No.: PCT/EP2021/082723

§ 371 Date: May 16, 2024

(51) Int. Cl. G06F 11/00

(52) U.S. Cl. CPC G06F 11/004

(57) ABSTRACT

Disclosed are apparatuses and methods for power supply fault prediction for a Radio Base Station (RBS) forming part of a communication network. The method comprises obtaining measurements of at least one of: input power characteristics of a Powers Supply Unit (PSU) of the RBS: power output characteristics of a power distribution unit of the RBS; and power input characteristics of radio units of the RBS. The method further comprises converting the obtained measurements into performance metrics characterising the performance of a RBS power supply. The method also comprises processing the performance metrics using a Machine Learning (ML) model to generate a power supply fault prediction.

### TECHNICAL FIELD

Embodiments described herein relate to methods and systems for power supply fault prediction, in particular methods and systems for power supply units fault prediction in Radio Base Stations forming part of communication networks.

### BACKGROUND

In urban and suburban areas, many Radio Base Stations (RBSs) are directly connected to the Alternating Current (AC) power grid. The quality of power supplied by the AC power grid may vary substantially with location. From a Mobile Network Operator (MNO), the number of RBSs is likely to increase with the implementation of new technologies. Hardware (HW) units that are deployed need to have a highly reliable and fault tolerant system, to avoid a substantially increased number of HW faults generated due to external power quality interrupts and/or external factors such as interference.

It is common for power to be provided over mains power networks using AC, but for components (such as communication network components) to require Direct Current (DC) power to operate. Accordingly, components of communications networks such as RBS and data centres typically comprise or are connected to a Power Supply Unit (PSU). PSUs may be used to convert between AC and DC, and to provide output power in the form required by equipment. By way of example, in a typical RBS, the PSU converts input AC power to regulated DC power, at a voltage that the RBS is configured to use (for example, it is common for RBSs to require-54.5V). Ensuring good operational performance of the PSU is paramount to a well-functioning RBS. The same is true for other components of communications networks, such as data centres, wherein again a correctly operating PSU is essential to a correctly functioning data centre.

Existing RBSs commonly use a Surge Protection Devices (SPDs), and may also or alternatively use Electromagnetic Interference (EMI) filtering techniques, to protect and reduce the impact of incoming power interruptions and interference from external sources. Unfortunately, if the SPDs are not properly designed and/or are installed incorrectly, the RBS may not be sufficiently protected from interruptions and interference, which may result in the performance of PSUs of RBSs specifically and of RBS components generally degrading. It may therefore be beneficial to monitor interruptions in the power supply to RBSs.

In typical RBSs the system architecture is arranged such that the AC distribution power interruptions are measured by the PM counter pmPsuAcInputVoltageInterruption. The PM counter is applied such that, whenever an AC interruption is detected, the time length of the interruption is measured and encoded into the counter, and the registered in accordance with the vector encoding definitions in Table 1 (in a vector, of length 10). A register accumulates the interruption times until it is reset to zero; incrementing a tally in the register whenever an interruption has happened.

| Position | Time span | |
|---|---|---|
| 0 | <20 | sec |
| 1 | [20, 60] | sec |
| 2 | [1, 3] | mins |
| 3 | [3, 10] | mins |
| 4 | [10, 30] | mins |
| 5 | [30, 60] | mins |
| 6 | [1, 2] | hrs |
| 7 | [2, 5] | hrs |
| 8 | [5, 10] | hrs |
| 9 | >10 | hrs |

FIG. 1 is a schematic overview of an example RBS architecture. A typical RBS may include one or more of the components shown in FIG. 1. The example RBS in FIG. 1 includes 3 input lines (L1, L2 and L3) providing connections to external power sources, such as AC mains power. The example RBS in FIG. 1 includes 3 PSUs, one for each of the input lines. The output from all of the PSUs is passed to a Power Distribution Unit (PDU), which distributes power to a number of Radio Units (RU); in FIG. 1, four RU are shown (Radio 1, Radio 2, Radio 3, Radio n+1). The PDU in the FIG. 1 example is also connected to a backup battery, which may be used as a power source in the event that the external power supply is unavailable, and also to a baseband (BB) unit.

As shown in FIG. 1, a RBS may be equipped with a number of sensors. The RBS shown in FIG. 1 is equipped with sensors for detecting AC interruptions, sensors for detecting variations in PSU system voltage output and sensors for detecting variations in RU input. The outputs from these sensors may be used to monitor the impact of incoming power interruptions and interference from external sources. Typically, incoming power interruptions and interference from external sources result in changes to the performance of components throughout the RBS. FIG. 2 is a plot showing an example of how the utilisation of a PSU (as may be detected, for example, using a PSU output sensor as shown in FIG. 1) may be caused to vary as a result of AC powers supply interruptions. In FIG. 2, time is plotted on the X axis (in minutes between 08:00 and 08:12) and utilisation of the PSU is plotted on the Y axis (as a percentage of maximum utilisation). The two shaded vertical stripes in FIG. 2 indicate periods of power supply interruption; each period lasting 1 minute. As indicated by the average, minimum and maximum lines on the FIG. 2 plot, the utilisation of a PSU may be caused to increase immediately after periods of power supply interruption as transmissions that have not been sent during the interruption are sent. During the period of interruption, the PSU may not function or may potentially function using battery reserves if available.

Although existing systems may provide information allowing the immediate response of (for example) PSUs to incoming power interruptions and interference from external sources to be measured, there is no mechanism for predicting the response of systems over time to potentially multiple instances of incoming power interruptions and interference from external sources. Existing systems for protection from incoming power interruptions and interference from external sources may not fully protect RBSs from the impacts of incoming power interruptions and interference from external sources, and accordingly the frequency of required maintenance may be impacted by the number of incoming power interruptions and interference from external sources. Further, failures of internal components (such as PSUs) within a RBS can impact the behaviour and/or lifetime of other components, again it is not currently possible to fully detect or calculate the impact of internal component failures.

### SUMMARY

It is an object of the present disclosure to provide methods, systems and computer readable media which at least partially address one or more of the challenges discussed above. In particular, it is an object of the present disclosure to provide PSU fault prediction that may more accurately predict PSU degradation and maintenance requirements and may support increased PSU lifetime and/or efficiency, and may also reduce instances of service outages due to PSU faults.

According to embodiments there are provided computer-implemented methods for power supply fault prediction for RBSs forming part of communication networks. A method comprises obtaining measurements of at least one of: input power characteristics of a PSU of the RBS; power output characteristics of a PDU of the RBS; and power input characteristics of RUs of the RBS. The method further comprises converting the obtained measurements into performance metrics characterising the performance of a RBS power supply. The method also comprises processing the performance metrics using a ML model to generate a power supply fault prediction.

In some embodiments, the obtained measurements may indicate a disruption in normal performance. The performance metrics characterising the performance of the RBS power supply may comprise at least one of: a time severity metric for the disruption in normal performance; and a voltage severity metric for the disruption in normal performance.

In some embodiments, the step of processing the performance metrics using the ML model may comprise generating a data point representative of the state of the RBS in a power supply feature space by the ML model using the performance metrics, and may further comprise determining a distance in feature space between the data point and a centroid of a cluster that represents normal behaviour of the RBS. The comparison between the distance in feature space and one or more predetermined distance thresholds may be used to generate the power supply fault predictions.

According to further embodiments, there are provided RBSs comprising processing circuitry and a memory containing instructions executable by the processing circuitry. A RBS is operable to obtain measurements of at least one of: input power characteristics of a PSU of the RBS; power output characteristics of a PDU of the RBS; and power input characteristics of RUs of the RBS. The RBS is further operable to convert the obtained measurements into performance metrics characterising the performance of a RBS power supply. The RBS is also operable to process the performance metrics using a ML model to generate power supply fault predictions.

### BRIEF DESCRIPTION OF DRAWINGS

The present disclosure is described, by way of example only, with reference to the following figures, in which:—

FIG. 1 is is a schematic overview of an example RBS architecture;

FIG. 2 is a plot showing an example of how PSU utilisation may vary as a result of AC powers supply interruptions;

FIG. 3 is a flowchart showing a method in accordance with embodiments;

FIGS. 4A and 4B are schematic diagrams providing overviews of RBSs in accordance with embodiments;

FIG. 5 is a plot showing an example of the change of the state for the pmPsuAcInputVoltageInterruption in relation to a given interruption;

FIG. 6 is a plot showing how the delay in obtaining a steady voltage supply may be calculated in accordance with embodiments;

FIG. 7 shows examples of the response of a RBS to power interruptions;

FIG. 8 shows an example of a power supply feature space in accordance with embodiments;

FIG. 9 shows how the clustering of results and the measurement of distances between data points and the centroids of clusters may be used in accordance with embodiments; and

FIG. 10 is a flow chart showing a method in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

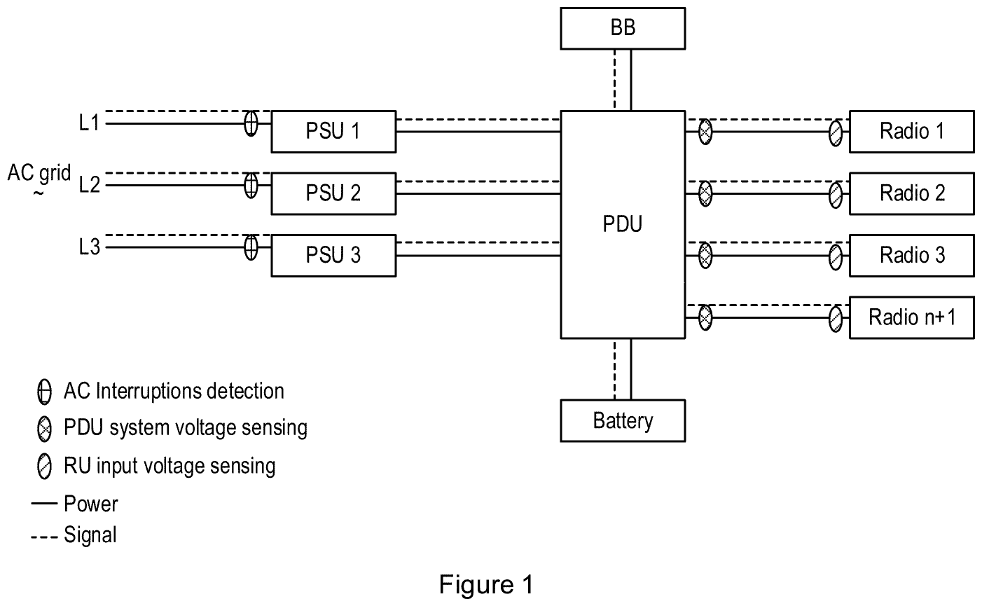

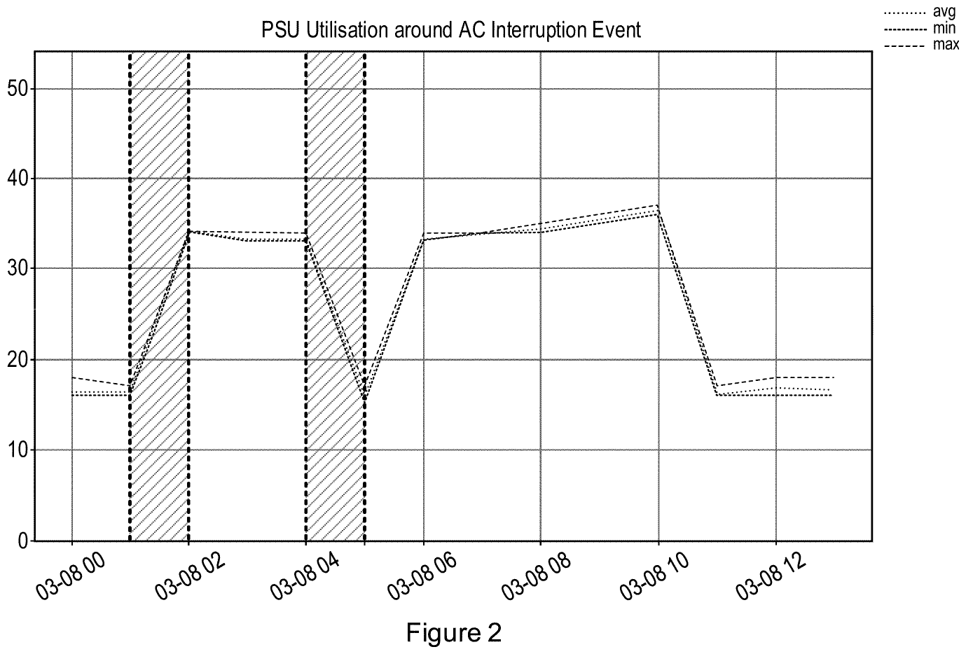

Some embodiments are configured to obtain performance metrics that characterise the performance of a RBS power supply. Measurements of at least one of the: input power characteristics of a PSU of the RBS; power output characteristics of a PDU of the RBS; and power input characteristics of RUs of the RBS are obtained, for example, using suitably located sensors as shown in FIG. 1. These measurements may then be converted into performance metrics characterising the performance of a power supply, and in particular characterising any disruption (for example, interruption) in normal performance of the input power to the RBS. Performance metrics like a time severity metric and a voltage severity metric may be utilised to characterise any disruption in normal performance. The severity metrics may vary (for example) between zero and one, where severity zero refers to the ideal by-design response, and one the total failure. The metrics characterise the RBS performance, rather than a disruption in input power itself, and therefore different RBSs could be characterised by different metric values in response to similar voltage interruptions. In some embodiments, the performance metrics may be used as inputs to a Machine Learning (ML) model to predict future RBS behaviour including predicting RBS power faults, potentially to schedule precautionary maintenance, and so on.

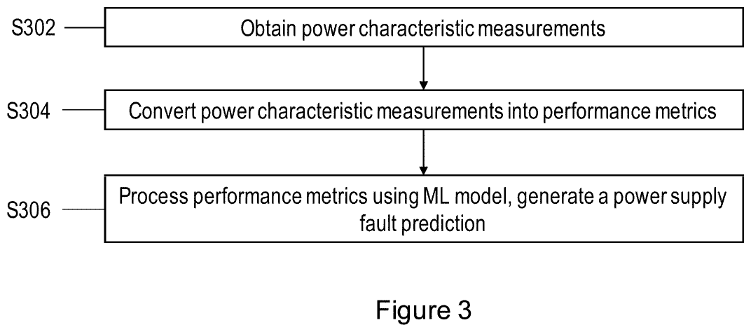

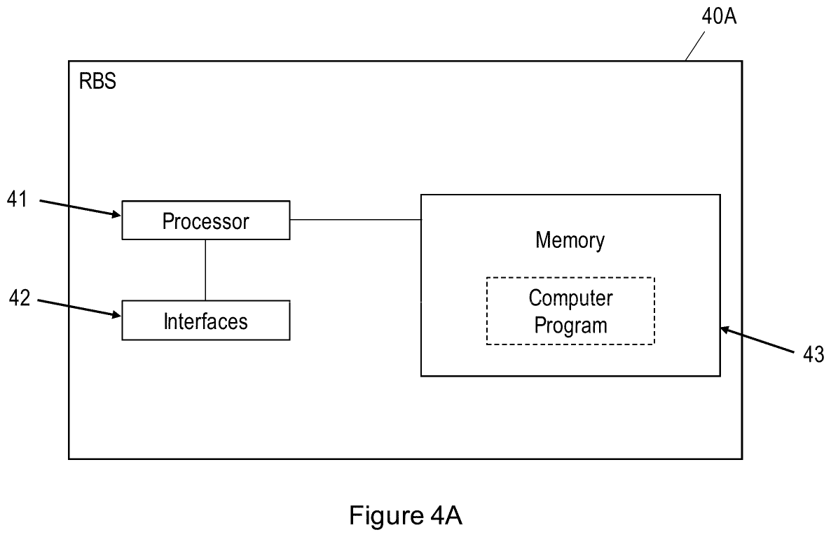

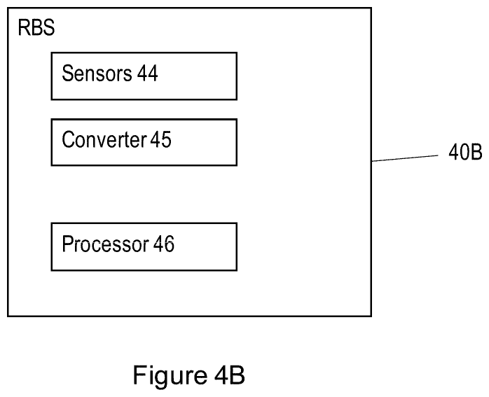

A method in accordance with some embodiments is illustrated in the flowchart of FIG. 3. The method may be executed by any suitable RBS, potentially operating as part of a larger system. Examples of suitable RBSs in accordance with embodiments that are suitable for executing the method are shown schematically in FIG. 4A and FIG. 4B. One or more of the RBSs shown in FIGS. 4A and 4B may form part of a communication network or system. Where the RBS forms part of a communication network, this network may further comprise another device (for example, another RBS, a core network node, and so on) that hosts the ML model. The RBS may initiate transmission of the performance metrics to the device, and the device may then receive the transmitted performance metrics and process these inputs using the ML model. Where the RBS forms part of a system, this system may further comprise a cloud computing system that hosts the ML model. The RBS may initiate transmission of the performance metrics to the cloud computing system, and the cloud computing system may then receive the transmitted performance metrics and process these inputs using the ML model.

As shown in step S302 of FIG. 3 the method comprises obtaining measurements of at least one of: the input power characteristics of a PSU of the RBS; power output characteristics of a PDU of the RBS; and power input characteristics of RUs of the RBS. As will be clear to those skilled in the art, the measurements may be obtained as required depending on the specific configuration of embodiments. Where a RBS 40A in accordance with the embodiment shown in FIG. 4A is used, the measurements may be obtained in accordance with a computer program stored in a memory 43, executed by a processor 41 in conjunction with one or more interfaces 42 (where the interfaces may comprise one or more sensors). Alternatively, where a RBS 40B in accordance with the embodiment shown in FIG. 4B is used, the measurements may be obtained by the sensors 44. In some embodiments, the measurement data may be collated by a further component, such as a memory unit forming part of the PSU or a separate memory unit located proximate to the PSU, and sent in one or more batches. Alternatively, the measurement data may be sent directly following measurement with no collation.

Once the measurements of power characteristics of the PSU have been taken, the obtained measurements may then be converted into performance metrics characterising the performance of the PSU, as shown in step S304 of FIG. 3. As discussed above, the performance metrics may indicate when a disruption in normal performance has occurred, and may characterise any such disruption using a time severity metric and/or a voltage severity metric. The time and voltage severity metrics may therefore individually or jointly be used to characterise the severity of an interruption in power supply to a RBS. In some embodiments, AC distribution power interruptions may be measured by the PM counter pmPsuAcInputVoltageInterruption as discussed above. Where available, this PM counter may be used in conjunction with measurements of the system voltages using (pmSVstemVoltage, pmVoltage) when deriving the performance metrics. The pmPsuAcInputVoltageInterruption can be used to define a binary state; the AC voltage is interrupted or not, that is, the pmPsuAcInputVoltageInterruption counter's vector has values other than zeroes. Where a RBS 40A in accordance with the embodiment shown in FIG. 4A is used, the performance metrics may be obtained in accordance with a computer program stored in a memory 43, executed by a processor 41 in conjunction with one or more interfaces 42 (where the interfaces may comprise one or more sensors). Alternatively, where a RBS 40B in accordance with the embodiment shown in FIG. 4B is used, the performance metrics may be obtained by the converter 45.

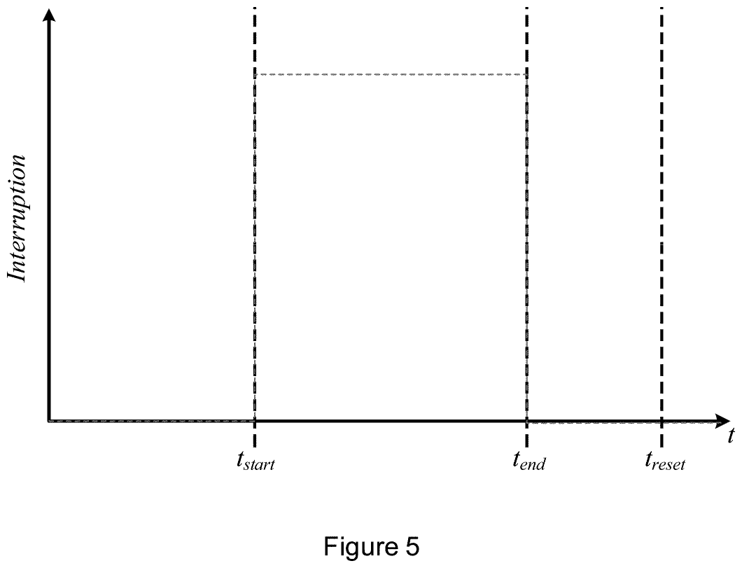

FIG. 5 is a plot showing an example of the change of the state for the pmPsuAcInputVoltageInterruption in relation to a given interruption. The x axis indicates time, and the y axis indicates the value of pmPsuAcInputVoltageInterruption. An AC power interruption begins at time tₛₜₐᵣₜ; the moment at which the power interruption is detected and the value of pmPsuAcInputVoltageInterruption becomes non-zero. The power interruption ends at time t_{end}; the moment in which the power is restored. It should be noted that the disruption to the operation of the RBS does not end at time t_{end}. Instead, following the return of normal AC power supply, there is an additional period of time until the RBS begins to receive normal service from internal PSU and PDU at time tᵣₑₛₑₜ (also shown on FIG. 5). AC power interruptions may be characterised by their absolute duration or duration relative to a reference time, e.g., hour, day, week, custom, and so on. Examples of equations which may be used to derive duration metrics (Dr) (absolute or relative) in accordance with embodiments are as follows:

$${D}_{T} = {t}_{end} - {t}_{start} or {D}_{T} = \frac{{t}_{end} - {t}_{start}}{{t}_{reference}} .$$

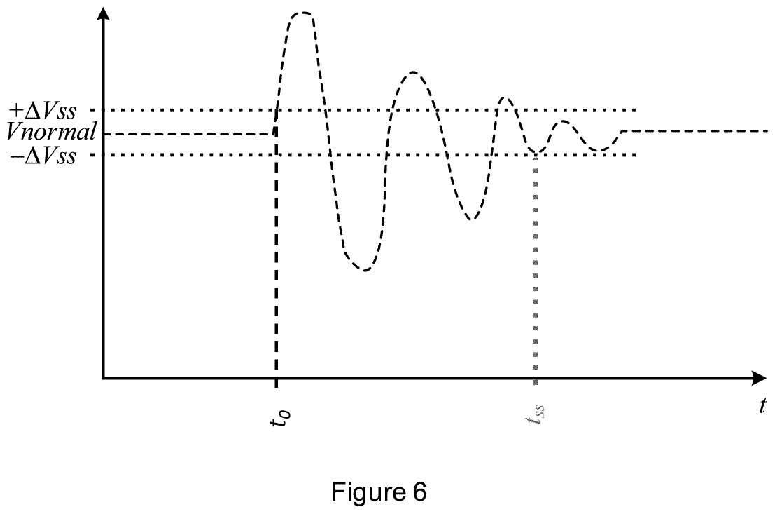

As mentioned above, a RBS may not return immediately to a normal operational state when AC power supply is restored. Instead, there may be an interval (the time between t_{end} and tᵣₑₛₑₜ in FIG. 5) following the restoration of AC power before the PSU and PDU are operating normally. A time severity metric S_{T} may be derived based on how long the RBS takes to receive a new steady voltage supply, potentially relative to a reference time. Any suitable time period may be used as a reference time, for example, the duration of the power interruption or a set period of minutes, hours, days, and so on. An example equation which may be used to calculate a time severity metric is

$${S}_{T} = \frac{{t}_{ss} - {t}_{int}}{{t}_{reference}}$$

where tᵢₙₜ is the duration of the interruption and t_{SS} is the time taken following the interruption in power supply for the RBS to receive a new steady voltage supply. By way of example, FIG. 6 shows how t_{SS} may be obtained. In FIG. 6, the horizontal axis is time and the vertical axis is the voltage received by the RBS. As can be seen from FIG. 6 the voltage is stable at Vₙₒᵣₘₐₗ until, at time to there is a momentary interruption in the power supply (for example, due to a PDU switching or adapting to a new operational setup, strictly speaking to is the end of the voltage interruption). The voltage level provided following the interruption is not immediately stable. Instead, as can be seen from FIG. 6, the voltage level oscillates with a decreasing amplitude of oscillation until a steady voltage supply resumes; in the example shown in FIG. 6, the steady voltages following the interruption is approximately the same as that before the interruption, although this is not always the case. The time at which a steady voltage supply is considered to be provided may be based on a user defined value, ΔV_{SS}, which defines a maximum allowable variation in the supply voltage relative to the normal value while the voltage is still considered to be in a steady state. As shown in FIG. 6, when the maximum variation in the supplied voltage is less than ΔV_{SS}, the voltage supply is considered to be in a steady state. The time between the end of the interruption (t₀) and the time at which the maximum variation in the supplied voltage is less than ΔV_{SS}, is t_{SS}.

In addition or alternatively to a time severity metric S_{T}, a voltage severity metric S_{V} may be used to characterise the performance of a RBS power supply. When there is an interruption in power supply for a RBS, the supplied power may fluctuate before stabilising (as discussed above). It is possible that the voltage supplied once the supplied power has stabilised may not be the same as that provided prior to the interruption in power supply, that is, the voltage supplied after the interruption (V_{fault}) may be different to the voltage supplied before the interruption (Vₙₒᵣₘₐₗ). The difference in the magnitude of the voltage before and after the interruption may be used to define a voltage severity metric S_{V}, for example, the voltage severity metric may be defined as

$${S}_{V} = \frac{{V}_{normal} - {V}_{fault}}{{V}_{normal}} .$$

The voltage may differ before and after an interruption for a number of reasons, for example, when the interruption is due to a failure of an external power source and the RBS switches to using a battery backup power source, or when one or more PSUs fail and the remaining PSUs are reconfigured to provide power for the components previously supplied by the failed PSUs.

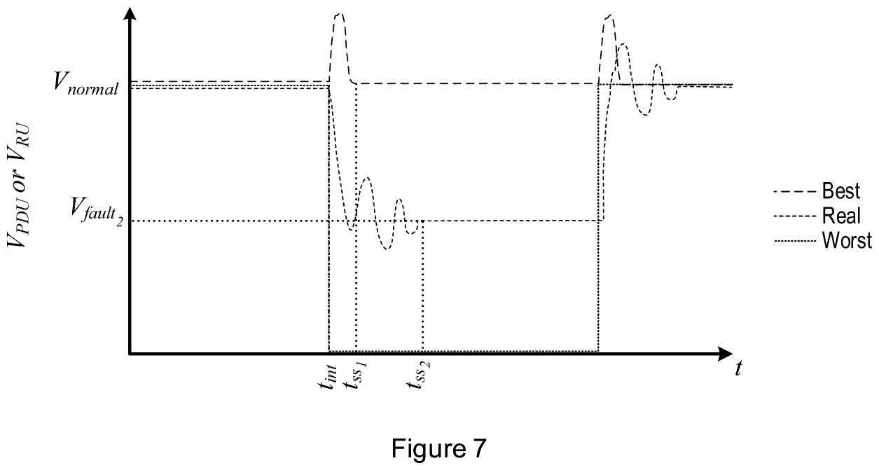

FIG. 7 shows examples of the response of a RBS to power interruptions. In FIG. 7, three different response scenarios are shown: a best case scenario (“best”), realistic scenario (“real”) and worst case scenario (“worst”), as indicated by the different dashed line patterns shown in the FIG. 7 key. The horizontal axis of FIG. 7 shows time, and the vertical axis shows the output voltage of the PDU (V_{PDU}) or input voltage of a RU (V_{RU}). In FIG. 7, the voltage is stable at Vₙₒᵣₘₐₗ until, at time tᵢₙₜ there is an extended interruption in the power supply, during which the RBS attempts to utilise battery reserve power to continue operations. As shown in FIG. 7, the best case scenario response of the RBS to a power interruption is a brief fluctuation in the voltage, before the voltage stabilizes at time t_{SS1} at the normal voltage; when the power supply returns following the interruption there is a further brief fluctuation before the voltage again stabilizes at the normal voltage. In the realistic scenario, the response of the RBS to a power interruption is a longer duration fluctuation in the voltage, before the voltage stabilizes at time t_{SS2} at voltage V_{fault2}, which is lower than Vₙₒᵣₘₐₗ; when the power supply resumes there is a further longer duration fluctuation in the voltage before the voltage stabilizes at Vₙₒᵣₘₐₗ. In the worst case scenario, the batter reserve power fails to provide power for the RBS when the external power supply is interrupted. Accordingly, at time tᵢₙₜ the voltage drops to zero and remains at zero until the external power supply resumes, at which time the voltage returns to Vₙₒᵣₘₐₗ. Each of these different scenarios may be characterised using one or more performance metrics, such as the time severity metric S_{T}, and voltage severity metric S_{V} as discussed above.

Once the obtained measurements have been converted into performance metrics, the performance metrics may then be processed using a Machine Learning (ML) model to generate a fault prediction for the power supply, as shown in step S306 of FIG. 3. Where a RBS 40A in accordance with the embodiment shown in FIG. 4A is used, the performance metrics may be processed in accordance with a computer program stored in a memory 43, executed by a processor 41 in conjunction with one or more interfaces 42 (where the interfaces may comprise one or more sensors). Alternatively, where a RBS 40B in accordance with the embodiment shown in FIG. 4B is used, the performance metrics may be processed by the processor 46. The ML model used to process the performance metrics may be hosted at the RBS 40, or may be hosted elsewhere (for example, in another part of the communication network such as a core network node or in a further apparatus connected to but not forming part of the communication network). In some embodiments the ML model may be hosted by a cloud computing system, which therefore acts as the ML agent. Those skilled in the art will be fully aware of how data may be transmitted over a variety of ranges, as dictated by the requirements of a specific embodiment. The nature of the ML model used to generate fault predictions may vary between different embodiments. In some embodiments, a general RBS ML model that is suitable for providing fault predictions for a number of different RBSs (potentially of different types, that is, different models of RBS having different numbers and configurations of internal components such as RUs, PDUs, and so on) may be used. In other embodiments, the ML model may be a RBS specific model that is specific to a given RBS and provides fault predictions for that RBS only.

Methods in accordance with some embodiments may further comprise a step of training the ML model (from an untrained or partially trained state) to provide the fault predictions. Techniques such as transfer learning and/or federated learning may be used to reduce the time and processing resources required for the training process, where embodiments include the training process. Alternative embodiments may obtain a trained ML model from a suitable database, and avoid the training process. Where embodiments include a step of training a ML model, the training data used (typically readouts from sensors in a RBS associated with indications of the subsequent performance of the RBS) may be specific to a RBS, or may relate to a plurality of different RBSs; the determination as to whether specific or more general training data is used is determined by whether the ML model to be used is a RBS specific ML model or general ML model, as discussed above. Further, the training data may be obtained from a variety of sources, including one or more RBSs operating in a communications network, and/or computer simulations of RBSs, and/or laboratory testing of RBSs or RBS components. The determination of what sources of training data to use may be made depending on the nature of the data that is available; typically, where available, real world data from RBSs operating in a network may be preferable to simulated data or data obtained from lab testing of RBSs or components. However, if there is no or insufficient real world data available, other sources may be used as discussed above. The training data may include information relating to configuration settings of the PSU (or other units), relations to the administrative state (such as active or inactive), information related to Quality of Service (QOS) and Quality of Experience (QoE) metrics of UEs connected to a RBS, and so on.

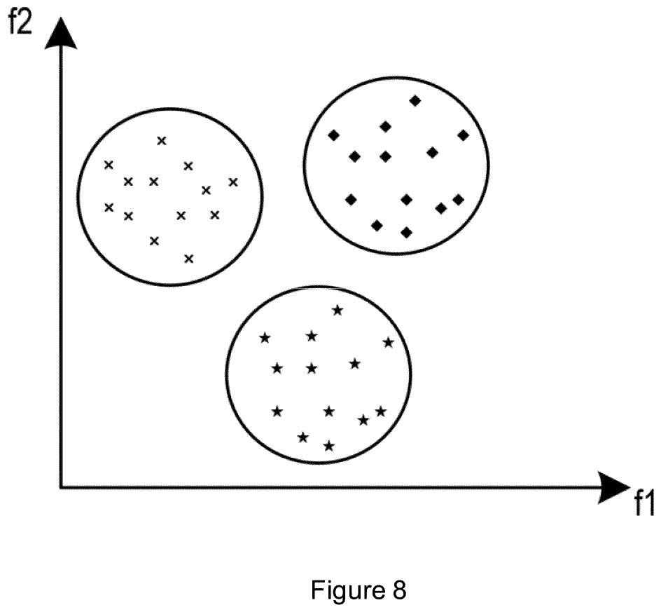

In some embodiments the ML model may, in the course of generating a power supply fault prediction, generate a data point using the performance metrics, wherein the data point is representative of the state of the RBS and is generated in a power supply feature space. An example of a power supply feature space is shown in FIG. 8. For simplicity the power supply feature space shown in FIG. 8 is two dimensional; the horizontal axis of FIG. 8 shows a first feature (f1) and the vertical axis shows a second feature (f2). Examples of the features that may be used to define the feature space include configuration inputs, QoS or QoE metrics, voltage levels, time durations relating to power interrupts (eg duration of interrupt), and so on. In typical embodiments that plot states of RBSs in a power supply feature space, the feature space may include a larger number of feature dimensions than that shown in FIG. 8. Different RBS configurations (that is, different models of RBSs having different numbers and arrangements of components, such as RUs, PSUs, and so on) may respond differently to equivalent power supply interruptions; the feature space shown in FIG. 8 includes data from three different RBS configurations. In FIG. 8, individual data points are not shown. Instead FIG. 8 includes three clusters of data points (indicated in the figure by vertical stripes, diagonal stripes and cross hatching). Each of the clusters represents the normal response of a RBS configuration to a power interruption. The clusters may be obtained using any suitable clustering algorithm, such as a K-nearest neighbors (KNN) or density-based spatial clustering of applications with noise (DBSCAN) algorithm, both as will be familiar to those skilled in the art. The clusters representing normal behaviour of RBS(s) may be obtained during the training of the ML model.

When performance metric(s) characterizing the performance of a RBS power supply, for example, following a disruption in normal performance of incoming power to the RBS, have been obtained, the ML model may use the performance metrics to position a data point in the feature space representing the RBS power supply performance. The distance between the data point and a centroid of a cluster representing the normal performance of the RBS may then be determined. Subsequently, this distance may be compared to one or more predetermined distance thresholds in order to generate power supply fault predictions, and/or to suggest actions that may be performed on the RBS. In some embodiments one of the predetermined distance thresholds may indicate, for example, the boundary in feature space between normal responses of a RBS to a power interruption and abnormal responses of the RBS. Other uses of the predetermined distance thresholds include, for example indicating an urgency of maintenance. The predetermined distance thresholds may specify distances in the feature space from the centroid of a cluster, and may be user specified or hard coded into the ML model. By way of example, where multiple thresholds are used to indicate an urgency of maintenance; when the distance between a data point and the centroid of a cluster is greater than a first distance threshold this may indicate that maintenance scheduling is advisable, while when the distance between a data point and the centroid of a cluster is greater than a second distance threshold (larger than the first threshold) this may indicate that urgent maintenance is required.

Where actions to be performed on the RBS are suggested, these suggested actions may comprise one or more of: deactivation of all or part of the RBS (for example, to protect all or part of the RBS from damage caused by future power abnormalities); reconfiguration of the RBS (for example, to reduce the load on components suspected to be nearing failure); scheduling maintenance of the RBS (to repair or replaced damaged components); and activation of further network components (such as additional RBSs) to compensate in case of failure of some or all of the RBS capabilities. In some embodiments, the method may further comprise performing one or more of the suggested actions on the RBS, and/or on the broader communication network comprising the RBS.

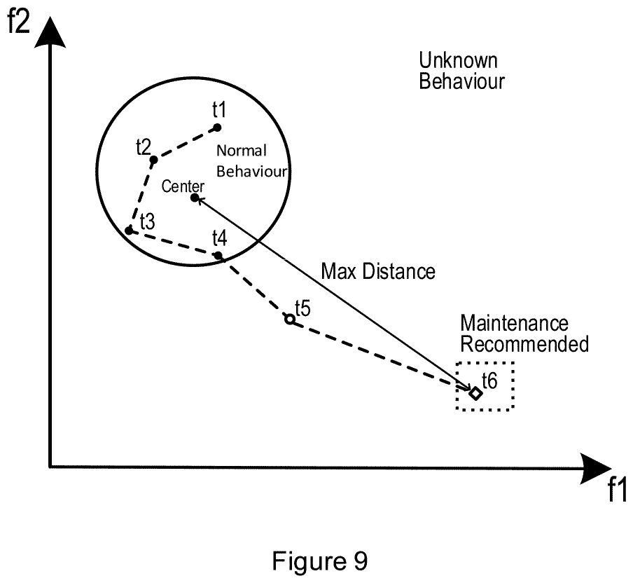

FIG. 9 shows how the clustering of results and the measurement of distances between data points and the centroids of clusters may be used. In FIG. 9, a single cluster is present; the centroid of this cluster is marked in the figure. A predetermined distance threshold is also shown in FIG. 9; this is centered on the centroid of the cluster. Data points within the threshold are considered to relate to RBS power supplies displaying normal behavior, while datapoints outside the threshold (that is, further from the centroid of the cluster than the predetermined distance threshold) relate to RBS power supplies displaying unknown or abnormal behaviour. The data points labelled t1 to t6 in FIG. 9 relate to a series of measurements (converted into performance metrics as discussed above) for the same RBS power supply over a period of time (for example, daily measurements over a period of 6 days); the measurements span the period of time and are ordered numerically with t1 as the earliest measurement and t6 as the latest measurement. As can be seen from FIG. 9, all of data points t1 to t4 are within the predetermined distance threshold from the centroid of the cluster, and are therefore considered to be normal behaviour. Data point t5 is outside the predetermined distance threshold; this is indicative of abnormal behaviour and may therefore result in a request for scheduled maintenance on the RBS power supply. However, data point t6 is significantly further from the cluster centroid than data point t5; this may indicate that the performance of the RBS power supply has deteriorated between the time of measurement of t5 and the time of measurement of t6. As a result of the separation between data point t6 and the centroid of the cluster, immediate maintenance of the RBS power supply may be suggested as an action to be taken, potentially accompanied by the partial or full deactivation of the RBS until maintained to prevent uncontrolled failure of the RBS power supply.

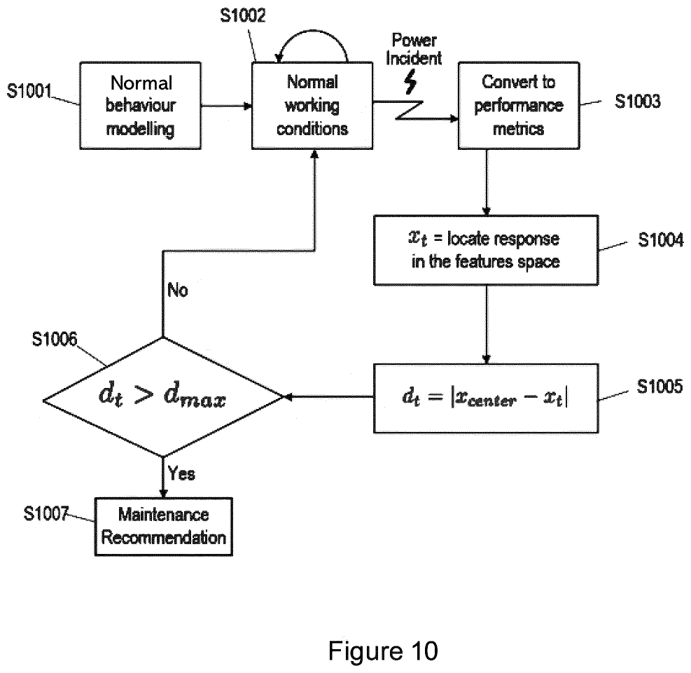

FIG. 10 is a flow chart showing a method in accordance with embodiments. In step S1001 of FIG. 10, a ML model is trained to model the behaviour of a RBS; in the FIG. 10 embodiment, the ML model is trained using data specific to the RBS, although as discussed above other embodiments may use more general RBS ML models. In step S1002, the RBS (and specifically the RBS power supply) are operating within normal parameters and the RBS is not subject to, for example, any power interruptions. Sensors may be used to measure the operation of the RBS components as discussed above (and as indicated by the curved arrow on step S1002); these measurements may include one or more of input power characteristics of a PSU, power output characteristics of a PDU, and power input characteristics of RUs, for example. A power incident, such as a power interruption, occurs, subsequently to which measurements are converted into performance metrics, as shown in step S1003. The performance metrics are then used to generate a data point representative of the state of the RBS in a power supply feature space by the ML model, as shown in step S1004; the data point is labelled as xₜ in FIG. 10. Subsequently, a distance (dₜ) between the data point xₜ and a centroid (x_{center}) of a cluster representing the normal behaviour of the RBS is determined, as shown in step S1005. In the embodiment shown in FIG. 10 the magnitude of the distance between the data point xₜ and a centroid (x_{center}) of the cluster is determined; typically the magnitude of the distance is used. The determined distance dₜ is then compared to a predetermined distance threshold dₘₐₓ in step S1006; based on this comparison it can be determined whether the RBS is exhibiting normal behaviour (No at step S1006) or abnormal behaviour (Yes at step S1006). If the RBS is exhibiting normal behaviour, then normal operation of the RBS may continue (see step S1002). By contrast, if the RBS is exhibiting abnormal behaviour, then actions to be performed may be suggested; in the FIG. 10 embodiment, a maintenance recommendation is sent to a system operator as shown in step S1007.

Methods in accordance with some embodiments may be implemented using existing hardware, that is, RBSs and other components of communication networks may be configured to implement methods in accordance with some embodiments by deploying a software update to the RBSs and/or other components. In other embodiments, it may be necessary to install further components, such as additional sensors in RBSs to monitor power characteristics.

Embodiments may allow earlier detection and/or prediction of failures in RBSs, which may support prevention of the failure (for example, through temporary deactivation of all or part of a RBS) and may also improve the scheduling of maintenance. In particular, maintenance may be more effectively target towards RBSs exhibiting abnormal behaviour, such that the behaviour may be rectified (through repair or replacement of damaged components, for example). As a consequence, embodiments may support more robust, fault tolerant systems having improved operational lifetimes and reduced instances of failure.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1-33. (canceled)

34. A computer-implemented method for power supply fault prediction for a Radio Base Station (RBS) forming part of a communication network, the method comprising:
obtaining measurements of at least one of: input power characteristics of a Power Supply Unit (PSU) of the RBS, power output characteristics of a power distribution unit (PDU) of the RBS, and power input characteristics of radio units (RU) of the RBS;
converting the obtained measurements into performance metrics characterising the performance of a RBS power supply; and
processing the performance metrics using a Machine Learning (ML) model to generate a power supply fault prediction.

35. The method of claim 34, wherein the obtained measurements indicate a disruption in normal performance.

36. The method of claim 35, wherein the performance metrics characterising the performance of the RBS power supply comprise at least one of: a time severity metric for the disruption in normal performance; and a voltage severity metric for the disruption in normal performance.

37. The method of claim 34, wherein, prior to the step of processing the performance metrics using the ML model, the ML model is trained.

38. The method of claim 37, wherein the ML model is trained using training data obtained from at least one of:
one or more RBSs operating in a communications network;
computer simulations of RBSs; and
laboratory testing of RBSs or RBS components.

39. The method of claim 34, wherein the step of processing the performance metrics using the ML model further comprises:
generating a data point representative of the state of the RBS in a power supply feature space by the ML model using the performance metrics, and
determining a distance in feature space between the data point and a centroid of a cluster, wherein the cluster represents normal behaviour of the RBS.

40. The method of claim 39, wherein a comparison between the distance in feature space and one or more predetermined distance thresholds is used to generate the power supply fault predictions.

41. The method of claim 39, wherein a comparison between the distance in feature space and the one or more predetermined distance thresholds is used to suggest one or more actions to be performed on the RBS, wherein the one or more actions comprise one or more of:
deactivation of all or part of the RBS;
reconfiguration of the RBS;
scheduling maintenance of the RBS; and
activation of further network components to compensate in case of failure of some or all of the RBS capabilities.

42. The method of claim 34, further comprising performing an action on the communication network based on the power supply fault predictions.

43. The method of claim 34, wherein the ML model is hosted by a ML agent forming part of a device in the communication network, and the method further comprises: by the RBS, initiating transmission of the performance metrics; and, by the device, receiving the transmitted performance metrics.

44. A Radio Base Station (RBS) comprising processing circuitry and a memory containing instructions executable by the processing circuitry, whereby the RBS is operable to:
obtain measurements of at least one of: input power characteristics of a Power Supply Unit (PSU) of the RBS, power output characteristics of a power distribution unit (PDU) of the RBS, and power input characteristics of radio units (RU) of the RBS;
convert the obtained measurements into performance metrics characterising the performance of a RBS power supply; and
process the performance metrics using a Machine Learning (ML) model to generate power supply fault predictions.

45. The RBS of claim 44, wherein the obtained measurements indicate a disruption in normal performance.

46. The RBS of claim 45, wherein the performance metrics characterising the performance of the RBS power supply comprise at least one of: a time severity metric for the disruption in normal performance; and a voltage severity metric for the disruption in normal performance.

47. The RBS of claim 44, further configured such that, prior to the step of processing the performance metrics using the ML model, the ML model is trained.

48. The RBS of claim 47, configured such that the ML model is trained using training data obtained from at least one of:
one or more RBSs operating in a communications network;
computer simulations of RBSs; and
laboratory testing of RBSs or RBS components.

49. The RBS of claim 44, further configured, when processing the performance metrics, to:
generate a data point representative of the state of the RBS in a power supply feature space using the ML model and the performance metrics, and
determine a distance in feature space between the data point and a centroid of a cluster,
wherein the cluster represents normal behaviour of the RBS.

50. The RBS of claim 49, further configured to use a comparison between the distance in feature space and one or more predetermined distance thresholds to generate the power supply fault predictions.

51. The RBS of claim 49, further configured to use a comparison between the distance in feature space and the one or more predetermined distance thresholds to suggest one or more actions to be performed on the RBS.

52. The RBS of claim 51, wherein the one or more actions comprise one or more of:
deactivation of all or part of the RBS;
reconfiguration of the RBS;
scheduling maintenance of the RBS; and
activation of further network components to compensate in case of failure of some or all of the RBS capabilities.

53. A communication network comprising the RBS of claim 44 and further comprising a device, wherein the ML model is hosted by a ML agent forming part of the device, wherein the RBS is configured to initiate transmission of the performance metrics to the device, and the device is configured to receive the transmitted performance metrics.
